(19) United States
(12) Patent Application Publication
(10) Pub. No.: US 2022/0402123 A1
(43) Pub. Date: Dec. 22, 2022

(54) STATE ESTIMATION FOR A ROBOT EXECUTION SYSTEM

(71) Applicant: X Development LLC, Mountain View, CA (US)

(72) Inventors: Tim Niemueller, Gauting (DE); Ryan Butterfoss, San Francisco, CA (US)

(21) Appl. No.: 17/353,609

(22) Filed: Jun. 21, 2021

(51) Int. Cl. B25J 9/16

(52) U.S. Cl. CPC B25J 9/163; B25J 9/1653; B25J 9/1661; B25J 9/1682

(57) ABSTRACT

Methods, systems, and apparatus, including computer programs encoded on computer storage media, for state estimation in a robotics system. One of the systems includes an execution subsystem configured to drive one or more robots in an operating environment including continually evaluating a plurality of execution predicates, wherein each execution predicate comprises a rule having a predicate value, and wherein, whenever a state value that satisfies the predicate value of the predicate is detected by the execution subsystem, the execution subsystem is configured to trigger a corresponding action to be performed in the operating environment by the one or more robots. A state estimator is configured to continually execute a state estimation function using one or more sensor values or status messages obtained from the operating environment and to automatically update a discrete state value for a first execution predicate of the plurality of execution predicates evaluated by the execution subsystem.

### BACKGROUND

This specification relates to robotics, and more particularly to executing robotic movements.

Robotics control refers to controlling the physical movements of robots in order to perform tasks. For example, an industrial robot that builds cars can be programmed to first pick up a car part and then weld the car part onto the frame of the car. Each of these actions can themselves include dozens or hundreds of individual movements by robot motors and actuators.

Traditional robotics control has traditionally required immense amounts of manual programming in order to meticulously dictate how the robotic components in a workcell should move in order to accomplish a particular task. Manual programming is tedious, time-consuming, and error prone. In this specification, a workcell is the physical environment in which a robot will operate. Workcells have particular physical properties, e.g., physical dimensions, that impose constraints on how robots can move within the workcell. Thus, a manually programmed schedule for one workcell may be incompatible with a workcell having different robots, a different number of robots, or different physical dimensions.

Attempts have been made to use sensor-rich environments to overcome the drawbacks of manual programming. For example, certain machine learning techniques, e.g., using reinforcement learning, have been used to learn robotic control policies using sensor inputs. However, robotic operating environments have a number of drawbacks that make traditional learning approaches unsatisfactory.

First, robots naturally have a very complex, high-dimensional, and continuous action space. Thus, it is computationally expensive to evaluate the full space of possible candidate actions, particularly in real time. An additional complication is that traditional techniques for using robotic learning for robotic control are extremely brittle. This means that even if it is feasible for a workable model to be successfully trained, even very small changes to the task, to the robot, or to the current state of the operating environment, can cause tasks to fail at an unsatisfactory rate or can cause the entire model to become unusable.

### SUMMARY

This specification describes an execution system for driving one or more robots that uses one or more independent state estimators to populate state values of rule-based execution predicates. This arrangement provides a flexible framework that can be used for online execution, offline planning, or both. The techniques described below also provide a robust architecture that allows for fast, rule-based execution with sensor-rich state estimators that can run independently.

In this specification, a state value is a discrete value that represents one of multiple states in an operating environment. A state value can represent relationships between entities in an operating environment, e.g., an object is “close” to a robot, or properties of one or more entities in an operating environment, e.g., a robot's operating status is “failed.”

Particular embodiments of the subject matter described in this specification can be implemented so as to realize one or more of the following advantages. Using an independent state estimator with a rule-based execution system allows for sophisticated machine learning algorithms to be incorporated into robotic control environments without incurring the computational complexity and brittleness of training end-to-end control models. An independent state estimator can execute on its own refresh rate outside of the main control loop of the execution system, which provides advantages of modularity and upgradability. In particular, the state estimator can be continually refined without altering or breaking the control logic of the execution system.

The independent state estimator also provides the additional capability of being utilized by both an online execution system and an offline planner. This arrangement improves the accuracy of the plans generated by the offline planner because the online execution system that is driving physical robots can use the same state estimator that was executed during offline planning.

In addition, the rule-based control logic of the execution system allows for automatic generation of training data for continually refining the state estimator. This means that the system can train a state estimator to empirically learn the boundaries of a particular state simply from tasks that failed or succeeded.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a flowchart of an example process for generating state values.

FIG. 3 is a flowchart of an example process for learning a state estimation function.

FIG. 4 is a more detailed view of the components of the execution engine subsystem and the execution memory subsystem.

FIG. 5 illustrates a flow using subscriptions and events.

FIGS. 6A, 6B, and 6C illustrate using a graph network to perform pattern matching.

FIG. 7 is a flowchart of an example process for executing rules.

Like reference numbers and designations in the various drawings indicate like elements.

### DETAILED DESCRIPTION

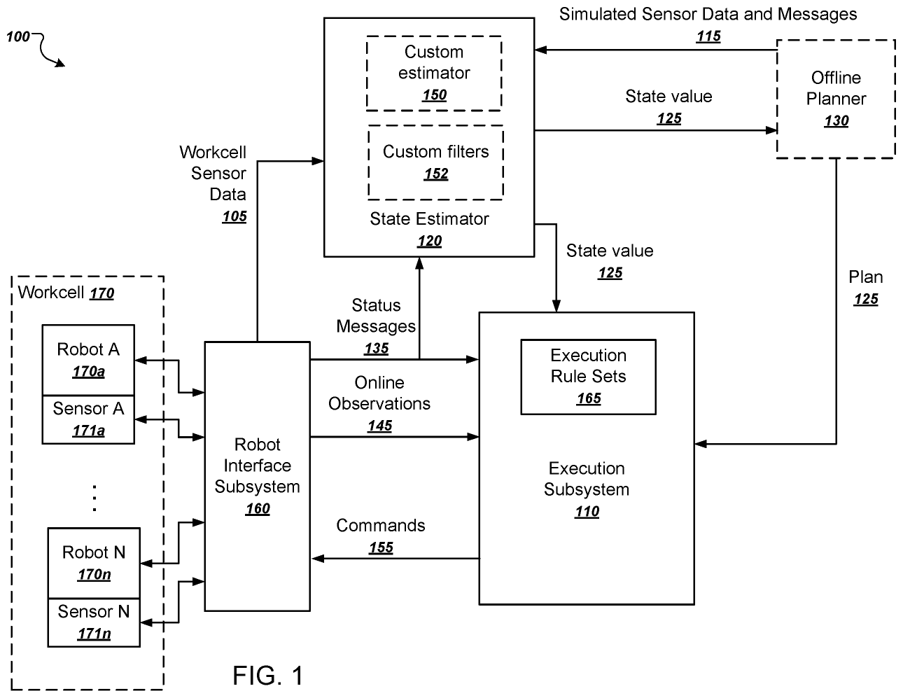

FIG. 1 is a diagram of an example system 100. The system 100 is an example of a system that can implement the state estimation techniques described in this specification.

The system 100 includes a number of functional components, including an execution system 110, a state estimator 120, an optional offline planner 130, and a robot interface subsystem 160. Each of these components can be implemented as computer programs installed on one or more computers in one or more locations that are coupled to each other through any appropriate communications network, e.g., an intranet or the Internet, or combination of networks.

In general, the execution system 110 provides commands 155 to be executed by the robot interface subsystem 160, which drives one or more robots, e.g., robots 170a-n, in a workcell 170. In order to determine which commands 155 to issue, the execution system 110 can consume status messages 135 generated by the robots 170a-n as well as online observations 145 made by one or more sensors 171a-n making observations within the workcell 170. As illustrated in FIG. 1, each sensor 171 is coupled to a respective robot 170. However, the sensors need not have a one-to-one correspondence with robots and need not be coupled to the robots. In fact, each robot can have multiple sensors, and the sensors can be mounted on stationary or movable surfaces in the workcell 170.

The robot interface subsystem 160 and the execution subsystem 110 can operate according to different timing constraints. In some implementations, the robot interface subsystem 160 is a real-time software control system with hard real-time requirements. Real-time software control systems are software systems that are required to execute within strict timing requirements to achieve normal operation. The timing requirements often specify that certain actions must be executed or outputs must be generated within a particular time window in order for the system to avoid entering a fault state. In the fault state, the system can halt execution or take some other action that interrupts normal operation. Similarly, the robots can be real-time robots, which means that the robots are programmed to continually execute commands according to a highly constrained timeline. For example, each robot can expect a command from the robot interface subsystem 160 at a particular frequency, e.g., 100 Hz or 1 kHz. If the robot does not receive a command that is expected, the robot can enter a fault mode and stop operating.

The execution subsystem 110, on the other hand, typically has more flexibility in operation. In other words, the execution subsystem 110 may, but need not, provide a command 155 within every real-time time window under which the robot interface subsystem 160 operates. However, in order to provide the ability to make sensor-based reactions, the execution subsystem 110 may still operate under strict timing requirements. In a typical system, the real-time requirements of the robot interface subsystem 160 require that the robots provide a command every 5 milliseconds, while the online requirements of the execution subsystem 110 specify that the execution subsystem 110 should provide a command 155 to the robot interface subsystem 160 every 20 milliseconds. However, even if such a command is not received within the online time window, the robot interface subsystem 160 need not necessarily enter a fault state. Thus, in this specification, the term “online” refers to both the time and rigidity parameters for operation. The time windows are larger than those for the real-time robot interface subsystem 160, and there is typically more flexibility when the timing constraints are not met.

The system 100 can also optionally include an offline planner 120. The overall goal of the offline planner 120 is to generate, from a definition of one or more tasks to be performed, a plan that will be executed by the robots 170a-n to accomplish the tasks. In this specification, a plan is data that assigns each task to at least one robot. A plan also specifies, for each robot, a sequence of actions to be performed by the robot. A plan also includes dependency information, which specifies which actions must not commence until another action is finished. A plan can specify start times for actions, end times for actions, or both.

The offline planning process is typically computationally expensive. Thus, in some implementations, the offline planner 120 is implemented by a cloud-based computing system having many, possibly thousands, of computers. The offline planner 120 is thus commonly physically remote from a facility that houses the workcell 170. On the other hand, the online execute engine 110 is often local to the facility that houses the workcell 170.

This arrangement can thus provide three different computing zones. The offline planner 120 can use massive cloud-based computing resources to consider many possibilities for scheduling tasks, while also allowing for online reaction to unanticipated events by the online execution system 110, while also providing the precision and real-time safety mechanisms of the robot interface subsystem 160.

Thus, in operation, the execution subsystem 110 can obtain a workcell-specific plan, e.g., a plan 125 generated by the offline planner 130, and issue commands 155 to the robot interface system 160 in order to actually drive the movements of the moveable components, e.g., the joints, of the robots 170a-n. In some implementations, the robot interface subsystem 160 provides a hardware-agnostic interface so that the commands 155 issued by execution subsystem 110 are compatible with multiple different versions of robots. During execution the robot interface subsystem 160 can report status messages 135 back to the execution subsystem 110 so that the execution subsystem 110 can make online adjustments to the robot movements, e.g., due to local faults or other unanticipated conditions. The robots 170a-n then continually execute the commands specified explicitly or implicitly by the motion plans to perform the various tasks or transitions of the plan.

The execution subsystem 110 can drive the actions of the robots 170a-n using rule-based logic as defined by execution rule sets 165. The execution rule sets 165 include execution predicates that specify when particular events trigger the execution of a particular action or plan. The main inputs to the execution subsystem 110 are thus (1) a plan 125, which can optionally be generated by a cloud-based offline planner 130 as described above; (2) the execution rule sets 165; and (3) a state value 125 generated by the state estimator 120.

The execution rule sets 165 specify particular patterns that, when matched, cause the execution subsystem 110 to trigger particular actions. As one example, suppose that a particular plan 125 specifies that a robot should execute a specialized action to pick up a hammer in the workcell, e.g., on a conveyor belt, when the state of the hammer changes from being farther away than 1 meter to being closer than 1 meter. A user developing the robotic workflow can express this functionality in an appropriate rule set language by writing an execution rule set that specifies (1) a pattern relating to closeness of the hammer, and (2) a body that specifies the action of picking up the hammer when the corresponding pattern is matched according to the state value 125.

In order to populate the state values of the execution predicates, the system can use an independent state estimator 120. In this specification, a state estimator is a subsystem that is configured to obtain sensor values, status messages, or both from a robotic operating environment and to generate a discrete value for a property of the operating environment that can be used in the body of execution predicates evaluated by an execution subsystem. This process can involve the state estimator monitoring streams of status messages 135 generated by one or more robots in the workcell or processing sensor data generated by sensors in the workcell. The state estimator 120 can for example transform quantitative measurements into qualitative measurements. For example, if the workcell sensor data 105 indicates that a component is less than 1 meter away from a robot, the state estimator 120 can convert this information into a state value 125 that represents the component being “close” rather than “not close.”

The output state value 125 of the state estimator 120 can be independently written into a location in a storage device that is accessible by the execution subsystem 120. Then, when the execution subsystem 120 evaluates a rule having a predicate value that is populated by the state value 125, the execution subsystem 120 can evaluate the state value 125 generated independently by the state estimator 120 and written into the storage device. In many cases, the system triggers an action when the state value first changes to a value that satisfies the predicate, which can represent a change in state in the operating environment. For example, if the state value of a pair of objects to be welded changes from “not close” to “close” as output by the state estimator 120, the system can trigger a robot to perform a welding action. As another example, if the state value of a robotic gripper changes from a held object being sensed to not being sensed, the system can trigger a recovery action to pick up the dropped object before continuing.

Optionally, the execution subsystem 110 can communicate with an online planner in order to generate plans at execution time. For example, if the state estimator 120 indicates that a hammer is closer than one meter away, the execution subsystem 110 can communicate with the online planner to generate a plan for picking up the hammer, given its recently observed position within the workcell 170. The online planner can also generate recovery plans to address situations where a required state of a particular execution rule set is suddenly not met.

The state estimator 120 being independent of the execution subsystem 110 means that the state estimator 120 need not depend on any control logic or execution flow of the execution subsystem 120. Rather, the state estimator 120 can operate on its own schedule and its own refresh rate.

Therefore, the control logic of the execution subsystem 110 need not depend on how long it takes for the state estimator 120 to generate the state value 125. This allows the execution subsystem 110 to run as quickly as is required by the task being executed. This arrangement can thus provide speed advantages over other approaches that require estimating the state of the operating environment inline with executing the execution logic.

The independence of the state estimator 120 also means that the implementation of the state estimator 120 can be refined over time without affecting the control logic of the execution subsystem 110 and without compromising the execution time of the execution subsystem 110. For example, the state estimator 120 can continually update and improve a deep neural network, or any other appropriate machine learning model, to generate the state value 125. This allows the system to continually improve without imposing major changes to the control logic of the execution subsystem 110. This arrangement is in stark contrast to end-to-end control policies that take sensor data as input and output a corresponding action. In those systems, updates require retraining vastly larger numbers of model parameters in order to update how the execution subsystem 110 should drivee the robots 170a-n. Therefore, the state estimator 120 can be updated and enhanced more rapidly than an end-to-end model, which can provide more rapid improvements to and greater stability of the robot installation in the workcell 170.

The independence of the state estimator 120 also provides modularity. For example, the state estimator 120 can use a custom estimator 150 that implements a custom state estimation module that defines how sensor data 105 or status messages 135 should be mapped to particular state values. In addition, the independence of the state estimator 120 allows users to write custom filters that filter out irrelevant status messages. For example, a user can write a custom filter that discards all messages except those that relate specifically to a particular robot arm.

TABLE 1 is an example of a custom state estimation function with a custom filter that indicates how a message can be transformed into a Boolean state value. The statements in TABLE 1 are written in a pseudocode expression language, although any appropriate expression language can be used.

TABLE 1

| | |
|---|---|
| 1 | state_fullname: “Partstatus” |
| 2 | predicate_expressions { |
| 3 | filter_expression: “p.name == ‘gripper’” |
| 4 | grounding_expression: “p.gripper_state.sensed_state == |
| 5 | SENSED_STATE_HOLDING” |
| 6 | param_values: [“Robot1”, “Part1”] |
| 7 | } |

On line 1, the function assigns a state name, “PartStatus,” to a state that the function will evaluate. This state name can then be referenced by other rules in the execution rule sets 165.

On line 2, the function declares predicate expressions that define the state estimation function.

On line 3, the function defines a first predicate expression that is a custom filter. The custom filter specifies analyzing only status messages having the string “gripper” in the part name field, which has the identifier “p.name.”

The state estimator 120 can operate on this custom filter, or any other custom filters, by repeatedly receiving streaming status messages 135 from the workcell and filtering out messages that do not satisfy the one or more criteria of the custom filter. The state estimator 120 can further process only messages that do satisfy the one or more criteria of the custom filter. And as mentioned above, because the state estimator 120 is outside of the path of real-time or near real-time execution occurring in the robot interface subsystem 160 or between the execution subsystem 110 and the robot interface subsystem 160, the state estimator 120 can operate independently at any appropriate frequency, which need not match or correspond to the update rates of any other subsystem.

On line 4, the function defines a grounding predicate that defines how data from the streaming messages can be transformed into a state value. In this example, the function defines a Boolean state value that is either true or false. The grounding predicate on line 4 assigns a truth value of true if the field “p.gripper_state.sensed_state” has a value corresponding to “SENSED_STATE_HOLDING” and a value of false otherwise.

On line 6, the function defines an optional set of additional parameters that must be satisfied in order to change the state. In this example, the additional parameters specify a particular robot, “Robot1,” and a particular part type, “Part1.” The optional set of parameters can be used to modify the state of only one robot or one part in a workcell rather than any robot or part in the workcell.

The modularity of the state estimator 120 allows the custom state estimation module and custom filters to be defined by a number of different entities that could be involved in different stages of implementing the robot installation in the workcell 170.

For example, a manufacturer of a robot can define the custom estimator function. This can be advantageous, for example, when the robot has integrated sensors over which the manufacturer has particular expertise, or when the state to be estimated relates to the robot itself.

As another example, an installer of the robotic installation in the workcell 170 can define the custom estimator function. This can be useful when the robotic installation is a custom installation for a specialized task. Thus, a custom setup of sensors in the workcell 170 can require the installer to develop a custom state estimation module to be executed by the state estimator 120.

As another example, an owner or an operator of the workcell 170 can define the custom estimator function. This can be advantageous, for example, when the items to be estimated include secret or proprietary information. For example, if the state estimator 120 is configured to compute the orientation of brand new car parts on an assembly line, the owner of the workcell 170 can use a newly trained machine learning model for the new car parts without exposing the design of the car parts to outside entities. Therefore, the modularity of the independent state estimator can also enhance the security of the robot installation in the workcell 170.

The independence and modularity of the state estimator 120 also allows it to be used by the offline planner 130. As described above, the offline planner 130 can be a remote, cloud-based distributed computing system that is configured to evaluate many thousands of different candidate plans and select a highest-scoring plan to actually be executed in the physical workcell 170. During the evaluation process, the offline planner 130 can perform simulations using virtual representations of the workcell 170, which can include virtual representations of the robots 170a-n, as well as simulated sensor data representing what sensors in the workcell would generate.

During this planning process, the offline planner 130 can use the same state estimator 120 that is used by the execution subsystem 110 during actual online execution. To do so, the offline planner 130 can provide simulated sensor data or status messages 115 to the state estimator 120. The state estimator 120 can then generate a state value 125 to be used by one or more rule sets under consideration during the planning process.

The rule sets used by the offline planner may, but need not, be the same as the execution rule sets 165 used by the execution subsystem 110 during online execution. In some implementations, the offline planner 130 evaluates multiple different collections of rule sets as part of the planning process. This arrangement allows for very rapid plan evaluation relative to the enormous computational complexity and expense of training multiple different candidate end-to-end control models.

Moreover, by using the same state estimator 120 during offline planning as online execution, the overall online performance of the plan 125 is likely to be very close to that which was achieved during offline planning. This is because the overall performance of a plan is often highly dependent on the quality of the state estimation, and when the state estimator is the same, the gap between offline and online state estimation quality is likely to be smaller.

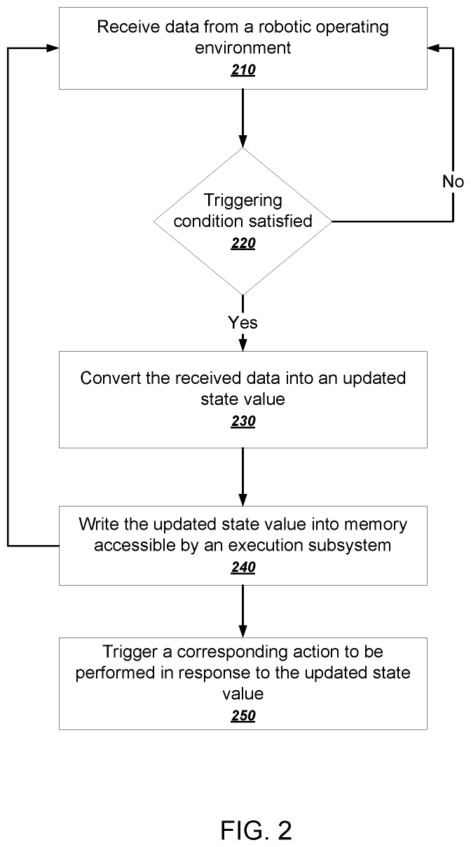

FIG. 2 is a flowchart of an example process for generating state values. The example process can be performed by a system of one or more computers, e.g., by the state estimator 120 of FIG. 1. The process will be described as being performed by a system of one or more computers.

The system receives data from a robotic operating environment (210). As described above, the data can include sensor values, status messages, or both. The robotic operating environment can be real or virtual, and likewise, the sensor inputs and status messages can either be real or simulated. The sensor inputs can be generated by any appropriate real or virtual sensor, e.g., cameras, depth sensors, force sensors, robot pose or joint angle sensors, and electrical charge sensors, to name just a few examples.

The system determines whether a triggering condition is satisfied (220). The triggering condition essentially specifies when the system should generate a new state value from the received sensor inputs. As described above, a state estimator can execute on particular refresh rate that is independent from the control logic and rule sets of an execution subsystem.

When processing status messages, the system can repeatedly process status messages streamed from the workcell. For sensor data, the triggering condition can be the passage of time from the last time that a state value was generated. Thus, for example, the system can determine that the triggering condition is satisfied every 10 ms, 100 ms, or 1 sec, to name just a few examples.

Alternatively or in addition, the triggering condition can be satisfied by an explicit invocation by an execution subsystem. For example, some control rules may require strictly updated state information in order to function properly. Thus, in some implementations the execution subsystem can invoke the state estimator to generate an updated state value at any time.

If the triggering condition is not satisfied (220), the system resumes receiving updated data from the workcell (branch to 210). If the triggering condition is satisfied, the system will generate an updated state value (branch to 230). In this context, the updated state value reflects the most up-to-date state value, but the updated state value need not be a different value from the current state value. The execution engine, however, may have execution rule sets that specify executing an action only when the state value changes.

The system converts the received data into an updated state value (230). As described above, the updated state value can be generated by a custom state estimation function. In some cases, the custom state estimation function can generate a Boolean value from the received data that indicates whether a particular workcell condition holds or not.

The state estimation function can also convert sensor data into a discrete state value. In this specification, a state value being discrete means that the state value is one of a limited number of possible options. For example, a state value can represent that an object is “close” to a robot or that a robot has a particular operating state. A state value can be numeric, when the range of possible numeric values is bounded. For example, the state estimator can compute one or more quantitative values from the one or more sensor inputs or status messages. For example, the system can use camera inputs to compute a distance between a robot and an object in the operating environment. As another example, the system can use joint sensor inputs to compute an angle between two joints of a robot or an angle of an orientation of a part of a robot. The state estimator can then convert the one or more quantitative values into a discrete state value. The exact mechanism of converting quantitative measurements in the operating environment into discrete state values will depend on the state estimation function as described above. For example, the state estimation function can deem that objects closer than 2 meters are considered close and all other objects are not considered close.

The system writes the state value into memory accessible by the execution subsystem (240). The execution subsystem can have reserved memory for the state values generated by the state estimator. The state estimator can then use any appropriate communications protocol, e.g., remote procedure calls, to write the updated state value into the memory of the execution subsystem. This arrangement of sharing storage space between the state estimator and the execution subsystem allows the state estimator to operate independently and at its own frequency.

The system triggers a corresponding action to be performed in response to the updated state value (250). For example, the execution subsystem can access the updated state value in the course of its normal operation. The updated state value can cause the predicate values of one or more rules to be satisfied, which can then cause the execution subsystem to initiate the execution of a corresponding action, e.g., welding two parts together when they are touching or close enough.

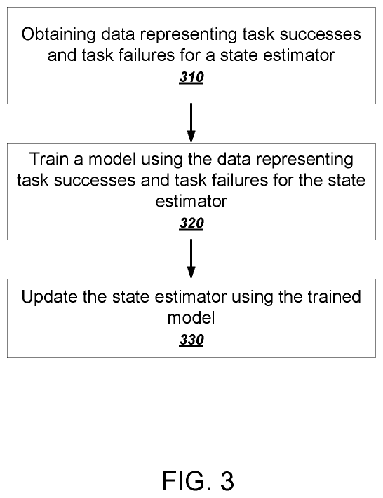

FIG. 3 is a flowchart of an example process for learning a state estimation function. A system can use successes or failures of tasks executed by robots in an operating environment as a proxy for the state that triggered the execution of such tasks. In this way, the system can learn empirically learn a state estimation function that does not rely on manually programmed values or values provided by a robot manufacturer. The example process can be performed by a system of one or more computers, e.g., by a distributed computing system that can but need not be implemented in the same cloud-based computing system as the offline planner 130 of FIG. 1. The example process will be described as being performed by a system of one or more computers.

The system obtains data representing task successes and task failures for a state estimator (310). Each state estimator is used by one or more tasks that are initiated by an execution subsystem in a physical or virtual operating environment. When a task is initiated, the control system of the operating environment can maintain a log that includes data representing whether each task failed or succeeded, what predicate triggered execution of the task, and one or more relevant values of sensor inputs and any state estimators that were involved. For example, the system can obtain such data for hundreds or thousands of successful and failed tasks in the operating environment.

Ordinarily there are vastly fewer failed tasks than successful tasks. Thus, the system can select the tasks to ensure that the failed tasks are adequately represented in the training data. For example, the system can select a substantially equal number of successful and failed tasks.

Because the execution system is rule-based, labeled training data can be automatically generated with no ambiguity at all. In other words, operators of the system need not try to define a definition of a particular state, such as closeness. Rather, the failures or successes of tasks are used a proxy for whether a state was actually achieved.

In order to bootstrap the process when no data about task execution yet exists, the system can use manually programmed values for the state estimator. For example, a state estimator for object closeness can be bootstrapped with a predetermined value, e.g., 0.5 or 1 meter. The system can then use the bootstrapped state estimator to perform multiple iterations of the task in order to generate training data from successful and failed tasks. The bootstrapped training data can be generated from tasks that were executed in physical or virtual operating environment.

The system trains a model using the data representing task successes and task failures for the state estimator (320). In general, the system can use the quantified sensor inputs as independent variables for the model in order to generate a prediction for the state value. The system can use any appropriate machine learning model and training procedure, e.g., a neural network with gradient descent backpropagation, to learn values that minimize an error between the predicted state value and the collected training data. In other words, during the course of the training process, the system can automatically learn, through the properties of successful and failed tasks, values for a model that more closely represents the empirical state of the operating environment.

As one simple example, the system could obtain task information about four tasks with the following state values and sensor quantifications. In this example, the sensor quantifications represent a distance between a robot and an object in the work cell:

TABLE 2

| Task | Sensor Quantification at Task Execution Time | Task Result |
|---|---|---|
| 1 | 0.62 | fail |
| 2 | 0.65 | success |
| 3 | 0.53 | success |
| 4 | 0.7 | fail |
| 5 | 0.4 | success |

The system can use this data to learn a model that uses the task results as a proxy for the state value. In performing the learning process, the model can converge on parameter values that indicate that the state value should be “close” when distances are closer than 0.61 meters. Although this is a simple one-dimensional example, in practice more sophisticated machine learning models are often required because the sensor quantifications can be more complex than simple scalar distances. For example, the inputs can be image values, which might be preprocessed by convolutional neural networks to recognize objects captured by the sensors.

In order to generate more failed tasks for training the model, the system can automatically vary the bootstrap definitions of the state values. For example, by setting the bootstrap state value for “close” to being 0.8 rather than the actual value closer to 0.6, the system can ensure that more failed task data is generated. This technique can be more feasible to do in simulation rather than in a physical workcell, particularly if safety and equipment issues are implicated in a physical workcell.

The system updates the state estimator using the trained model (330). For example, if the training process was purely in simulation, the system can download the trained model for use in the physical workcell to process actual physical objects.

The system can perform additional iterations to continually refine the quality of the state estimator. For example, after robots in the workcell operate on physical objects using the learned state estimator, the system can upload the results of those tasks to the training system.

The system can then re-learn the state estimator model using the data generated from the physical workcell. In this way, the system can continually refine the empirical definition of states that are generated by the state estimator. In addition, the accuracy of the state estimator can be continually improved without relearning an end-to-end control policy for the operating environment.

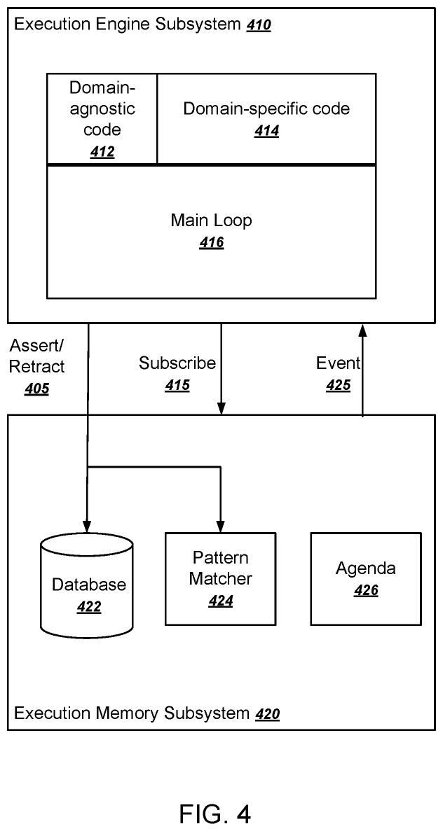

FIG. 4 is a more detailed view of the components of the execution engine subsystem and the execution memory subsystem. Aspects of these technologies are described in commonly owned U.S. patent application Ser. No. 16/885,015, which is incorporated herein by reference.

The execution engine subsystem 410 provides the framework to match events generated from pattern matches to invoking procedures. The patterns can be matched as a result of state values generated by a state estimator, as described above. The logic of the execution engine subsystem 410 is split into two parts, a domain-agnostic part 412, which contains general rules of operation, such as how to process and execute a plan; and a domain-specific part 414.

The domain-specific code 414 can include domain- or application-specific rule sets, for example, to monitor for specific conditions expected to occur and specific instructions on how to mitigate problems. For example, the system can monitor for errors which have been observed but which the general monitoring mechanisms do not yet recognize.

The execution memory subsystem 420 stores data in a database 422 and performs pattern matching with the pattern matcher 424.

The database 422 stores facts. Each fact can be represented as an instance of a message in a structured, hierarchical, data language. In other words, the content of a message can include one or more other messages. The execution engine subsystem 410 can modify facts in the database 222 by providing assert or retract requests 405.

The database 422 can assign a unique fact index to each fact in the database 422. Once stored, the database 422 can enforce the immutability of facts. Thus, in order to change a fact about the operating environment, the fact must be removed from the database 422 and added again, which causes the fact to be assigned a new fact index.

The pattern matcher 424 is a module that issues events in response to newly matched rule set patterns. Clients can subscribe to events described by a pattern by issuing a subscription request 415 to the pattern matcher 424. A pattern lists a number of variables and their type, e.g., what type of message to expect, and an expression over these variables. The variables determine the potential set of facts from the database for which the pattern is tested.

The segregation of the pattern matching functionality of the execution memory subsystem 420 from the code execution functionality of the execution engine subsystem 410 allows the execution memory subsystem 420 to service more clients than merely the execution engine subsystem 410. For example, an online planner of the system can use events generated by the pattern matcher 424 in order to inform planning decisions. For example, if a hammer is nearby, the online planner might plan a slower movement to reach the hammer than when the hammer is far away.

In some implementations, the pattern matcher 424 does not add or delete facts due to evaluation of patterns, which means that facts cannot be modified in-place. In addition, the pattern matcher 424 can generate events 425 only for newly matched patterns. In other words, the pattern matcher 424 can bypass generating events for which a pattern matches existing data in the database 422 at the time of subscription. This substantially reduces the amount of events that are triggered, which in turn makes processing the events much more efficient.

The pattern matcher 424 can use any appropriate pattern matching algorithm. In some implementations, the pattern matcher 424 uses the Rete algorithm with a Common Expression Language. The Rete algorithm analyzes the tests and creates a pattern matching network separated into two parts: the first alpha network matches the part of the patterns which concern only a single variable/fact. The beta network then performs a join on the parts of the pattern that concern two variables. In the end is a set of leaf nodes corresponding to the events of interest. On addition or removal of a fact, e.g., due to robot actions, rule processing, or new sensor observations, the pattern matcher 424 can reevaluate the network to determine if the fact update causes a new event.

Newly generated events are placed on the agenda 426, which is a data structure that is used for performing agenda deconfliction.

In other words, the agenda 426 is used to determine which event should be emitted first in the case that multiple events were activated by pattern matching on a newly added or removed fact. Processors of the events might in turn make changes that would invalidate other events on the agenda, which would hence not be called.

The execution engine subsystem 410 is a processing framework that provides a generalized way to map events emitted by the execution memory subsystem 420 to executable code. This mapping is a rule, with a rule head describing the pattern, and a rule body which is the lambda function to execute. The execution engine subsystem 410 can implement the code using any appropriate framework, for example, using a high-level programming, e.g., C, C++, or Python, or using a custom formal language.

The execution engine subsystem 410 then operates on rule sets that provide the functionality to execute and to monitor plans. One rule set can provide basic handling of information, for example, to determine whether an action becomes executable as new information becomes known. Further rule sets can enable the execution of plans having different semantics, for example, sequences of actions that have to be executed in a specific order one action at a time, or a partially ordered plan where some actions may be executed in parallel, which is common in operating environments having multiple robots. Further rule sets can provide the functionality for execution monitoring, for example, for ensuring the safety of human operators and equipment.

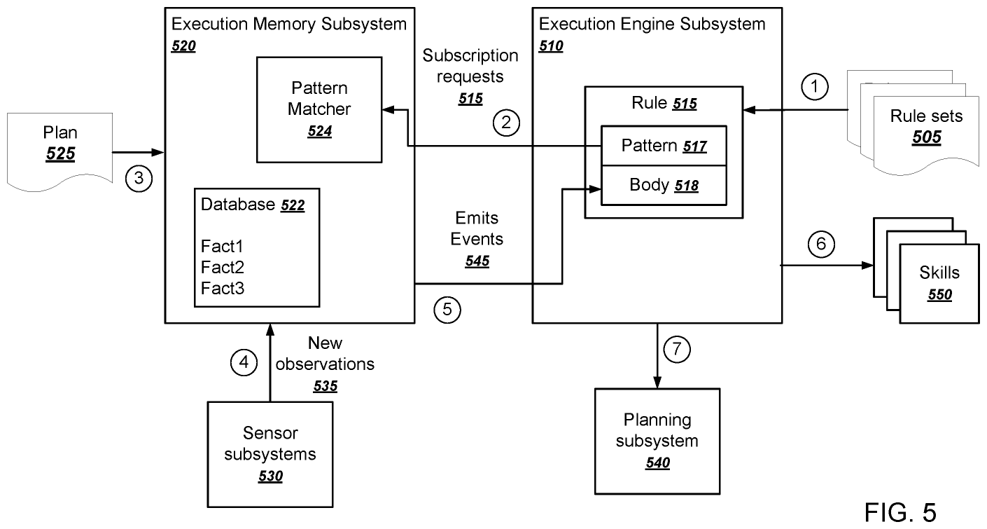

FIG. 5 illustrates a flow using subscriptions and events. As discussed above, the system includes an execution engine subsystem 510 and an execution memory subsystem 520. These subsystems receive information feeds from sensor subsystems 530 and interface with planning subsystems 540 and systems for executing skills 550. For clarity, the operational flow will be described step-by-step, but in practice, such steps can be happening in a different order and multiple of such steps can be happening continually and in parallel.

At step 1, the execution engine subsystem 510 loads rule sets 505.

At step 2, the execution engine subsystem 510 provides subscription requests 515 to the pattern matcher 524 by providing the patterns 517 of the rule sets 505.

At step 3, the execution memory subsystem 520 receives a plan 525 to execute. The plan 525 and the subscription patterns 517 are stored as facts in the database 522.

At step 4, new observations 535 are received from the sensor subsystems 530, and the facts in the database 522 are updated accordingly.

At step 5, the pattern matcher 524 evaluates the newly added or retracted facts in the database 422 to determine if any patterns are newly matched. If so, the execution memory subsystem emits one or more events 545 to the execution engine subsystem 510.

At step 6, the execution engine subsystem 510 maps the received events to rules and executes the corresponding rule bodies, which in turn can either cause data changes in the execution memory subsystem 520 or invoke the performance of skills 550.

At step 7, if an execution monitoring rule set detects a fault or another exception, the planning subsystem can be invoked to generate a recovery action or a correction plan.

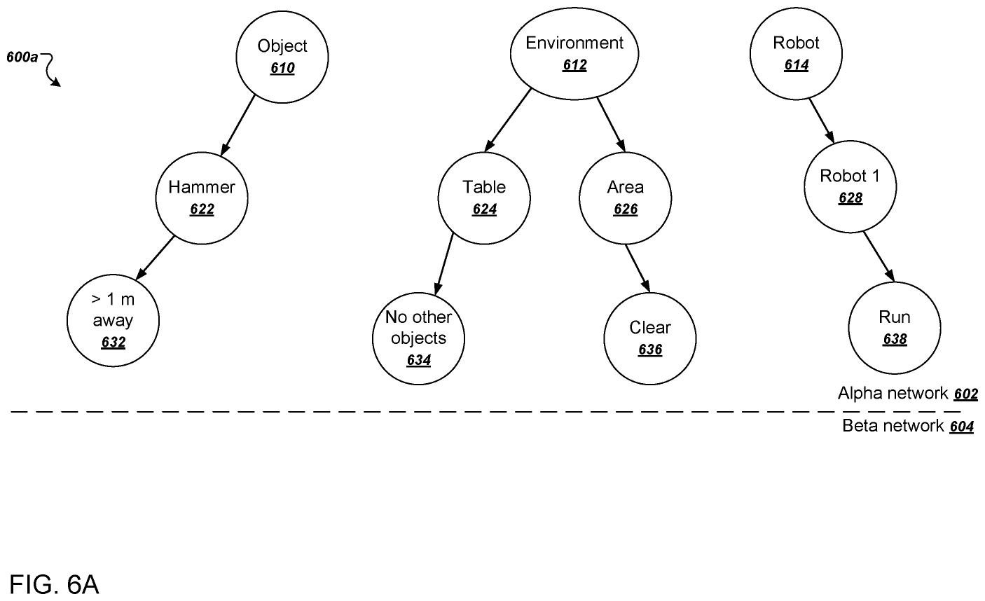

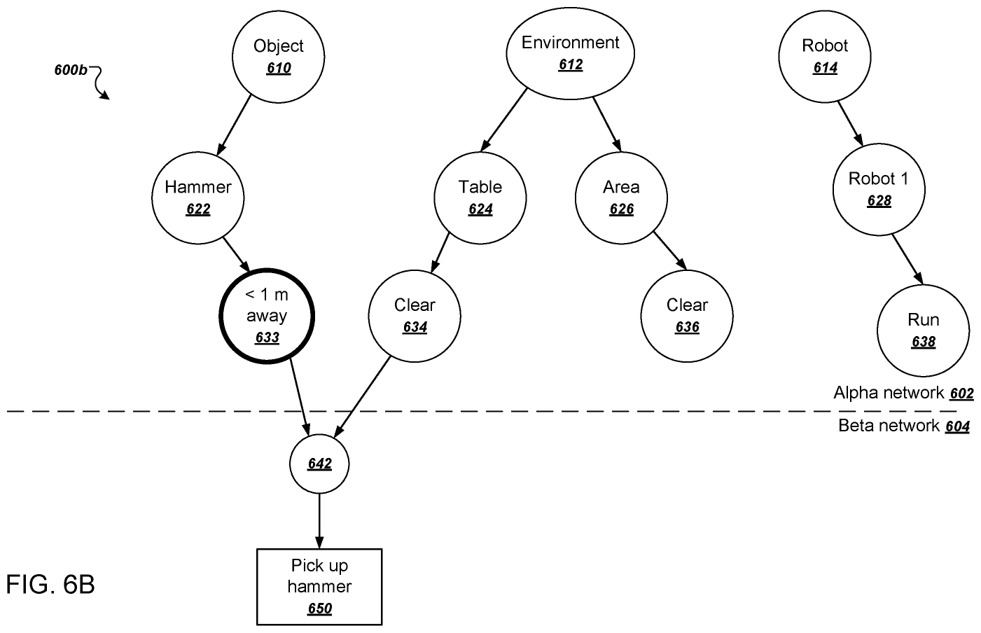

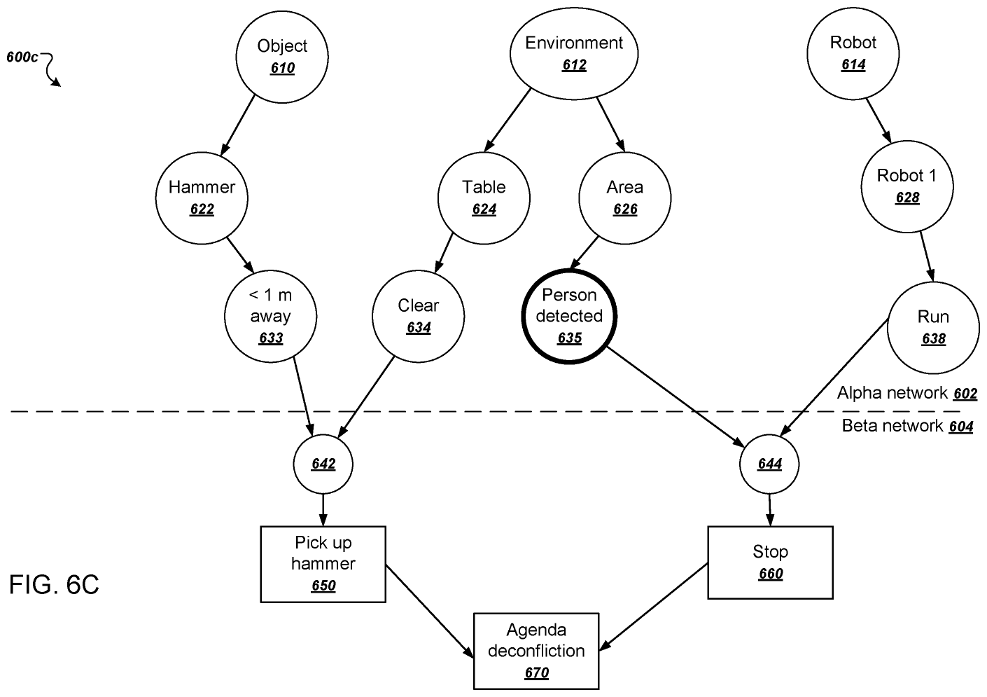

FIGS. 6A-6C illustrate using a graph network to perform pattern matching. This example illustrates two simple rules, one related to a robot picking up a hammer when it is nearby, and one related to environment safety.

The first example rule is shown in TABLE 3, expressed in pseudocode of an example expression language:

TABLE 3

| | |
|---|---|
| 1 | Object: hammer |
| 2 | Condition1: distance < 1 m |
| 3 | Condition2: table has no other objects |
| 4 | Action: Execute pick_up_hammer skill |

The example rule has a number of fields.

On line 1, a first field indicates the message type that will match this rule and a message subtype. In this example, the message type is “object,” and the message subtype is “hammer.”

On line 2, the field specifies a first condition as a distance constraint, which is that the distance between a robot and the hammer must be less than 1 meter.

On line 3, the field specifies a second condition as an environmental constraint, which is that the table on which the robot is operating has to be clear of other objects.

On line 4, the field specifies an action to be taken, which is that the robot should execute a “pick_up_hammer” skill.

The second example rule is shown in TABLE 4:

TABLE 4

| | |
|---|---|
| 1 | Robot: robot1 |
| 2 | Condition1: State = Run |
| 3 | Condition2: Area = person detected |
| 4 | Action: Execute stop |

On line 1, a first field indicates that message type is “robot,” and the message subtype is “robot1.” In other words, this rule relates only to robots and specifically to a robot with an identifier of “robot1.”

On line 2, the field specifies a first condition as a state constraint, which is that the robot is in a running state.

On line 3, the field specifies a second condition as an environmental constraint, which is that the environment has a person within the workcell.

On line 4, the field specifies an action to be taken, which is that the robot should perform an emergency stop action.

FIG. 6A illustrates a graph network 600a after initialization of the alpha network 602 using the fields shown in the example rules. The graph includes a first layer of type nodes 610, 612, and 614. The system can use the type nodes as a guard for fact updates that are received by the system. This allows for efficient processing because a single fact update will traverse only a single initial node in the first layer of type nodes.

Each of the direct children of the type nodes are subtype nodes that represent entities in the working environment about which fact updates can have an impact. In this example, the graph includes the following subtype nodes: a hammer node 622, a table node 624, an area node 626, and a robot 1 node 628.

The direct children of the subtype nodes represent facts for satisfied conditions in the rules. In the initial state, these facts are represented by a greater-than-one-meter node 632 that applies to the hammer node 622, a no-other-objects node 634 that applies to the table node 624, an area-clear node 636 that applies to the area node 626, and a run-state node 638 that applies to the robot 1 node 628.

With this state of conditions, no actions are triggered because there are no rules for which all conditions are satisfied. Thus, the beta network 604 is empty.

FIG. 6B illustrates a graph network 600b after a new message is received. In this example, the system generates a new message to represent a new observation that the hammer is now less than one meter away. The contents of the new message are illustrated in TABLE 5:

TABLE 5

| | |
|---|---|
| 1 | Object: hammer |
| 2 | Distance < 1 m |

As shown, the message includes a type of “Object,” and a subtype of “hammer.” Using this fact update to traverse the graph modifies the alpha network 602 by adding a node 633 to represent that the hammer is less than 1 meter away.

The system then populates the beta network 604 by generating a joint node 642 to represent that the conditions of the nodes 633 and 634 occur in the same rule. And because all conditions of the first rule are satisfied, the system then generates an event 650 to represent that the action of the rule can be triggered.

Thus, the execution subsystem can trigger the robot to perform the skill for picking up the hammer. Notably, because of the construction of the alpha network 602 and beta network 604 and the strongly typed messages, none of the other nodes in the graph 600b needed to be evaluated, thereby improving the computational efficiency when deciding which actions to take.

FIG. 6C illustrates a graph network 600c after another new message is received. In this example, the system generates a new message to represent a new observation that a person has been detected in the workcell. The contents of the new message are illustrated in TABLE 6:

TABLE 6

| | |
|---|---|
| 1 | Environment: Area |
| 2 | Person detected |

The message includes a type of “Environment,” and a subtype of “Area.” The message contents represent that sensors have detected a person entering the workcell.

Using this fact update to traverse the graph modifies the alpha network 602 by adding a person-detected node 635 to represent that a person has entered the workcell.

The system then populates the beta network 604 by generating a new joint node 644 to represent that the conditions of the nodes 635 and 638 occur in the same rule. And because all conditions of the second rule are now satisfied, the system then generates an event 660 to represent the action of performing an emergency stop.

At this point in the process, two conflicting actions have been triggered: picking up the hammer 650 and performing an emergency stop 660. Thus, the system can perform agenda deconfliction 670 to determine which of the rules to execute. In some situations, the system can perform all of multiple rules if none of the rules are conflicting. However, in this example, performing an emergency stop conflicts with picking up the hammer.

In some implementations, the system automatically classifies rules into a hierarchy according to safety considerations. For example, the hierarchy can have rules relating to user safety highest, rules relating to robot safety next, rules relating to product safety next, and normal operation rules last. Thus, for example, a rule relating to user safety will always overrule a rule relating to robot safety.

In this example, performing the emergency stop is a rule relating to user safety, and thus it overrides the first rule because it merely relates to normal robot functions. Accordingly, the execution subsystem can cause the robot to perform the emergency stop instead of picking up the hammer.

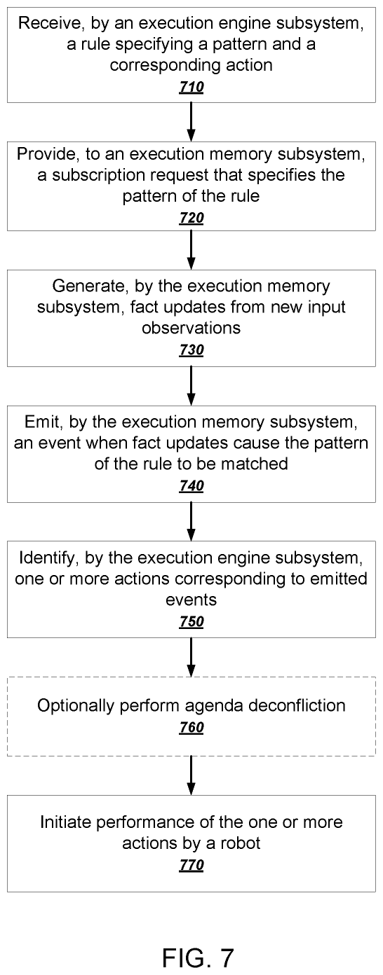

FIG. 7 is a flowchart of an example process for executing rules. The example process can be performed by an appropriately programmed execution subsystem having one or more computers in one or more locations, e.g., the execution subsystem 120 of FIG. 1. The process will be described as being performed by an appropriately execution engine subsystem and execution memory subsystem.

The execution engine subsystem receives a rule specifying a pattern and a corresponding action (710). As described above the rule can have a type and a subtype that specifies properties of entities in the working environment of a robot. The pattern of the rule can include a set of conditions that relate to the entities in the working environment and how they relate to one another in time or space.

The execution engine provides to an execution memory subsystem a subscription request that specifies the pattern of the rule (720). As described above, the overall architecture of the execution system can maintain a separation between the execution engine subsystem and the execution memory subsystem, which allows other clients in the system to also provide subscription requests to the execution memory subsystem.

For example, a perception subsystem that drives sensors in the workcell can subscribe to the execution memory subsystem in order to receive messages that represent necessary configuration changes. The configuration changes can be due to fault conditions or a change in the robot's tasks. For example, a change in the type of object that is being assembled can require a change to the configuration of the perception system, which can be driven by a fact update in the execution memory subsystem.

As another example, a robot configuration subsystem can subscribe to the execution memory subsystem to receive messages that represent updated robot configurations. The robot configurations can be updated to change speed and other safety limits depending on various fact updates. For example, if a human is detected in the workcell, that fact update can trigger a message to the robot configuration subsystem to alter one or more speed or safety limits.

The execution memory subsystem generates fact updates from new input observations (730). The execution memory subsystem can update a database with the fact updates, which can cause facts to be added to the database or facts to be removed from the database.

The execution memory subsystem emits an event when a fact update causes a pattern of a rule to be matched (740). In order to prevent an overflow of events being emitted by the system, the execution memory subsystem can be configured to emit an event only upon the first instance of the pattern being matched. In some implementations, the facts are immutable in the database, meaning that fact updates can only add new facts that supersede prior facts or remove existing facts in the database. The emitted events are received by their respective clients, which can include the execution engine subsystem or other clients, e.g., a planner.

The execution engine subsystem identifies one or more actions corresponding to the emitted events (750). Each event can include an identifier of a rule whose pattern caused the event to be emitted. The execution engine subsystem can thus look up the corresponding action for the pattern that caused the event to be emitted.

The execution engine subsystem can also optionally perform agenda deconfliction (760). Part of the deconfliction process can involve a hierarchy for enforcing safety constraints, and the execution engine subsystem can select an action for a rule having the highest level on the hierarchy. For example, the hierarchy can include these levels from highest priority to lowest: user safety, robot safety, product safety, normal.

The execution engine subsystem initiates performance of the one or more actions by a robot (770). As described above, this can cause control to transition from domain-agnostic code to domain-specific code. For example, instead of the robot execution domain-agnostic code about which action to perform next, the system can transition to domain-specific code for performing a particular skill, e.g., sanding a surface, welding a part, or attaching a connector. After the particular skill has been completed, control can transition back to the domain-agnostic code.

In addition to the task execution implementations described above, the execution memory subsystem can be used to serve more generally as a central component to collect, process, and disseminate information about the robot's environment. All components of the system could then deliver data to the execution memory subsystem to ingest. Rules would apply automatic updates to the data, synchronize different data sources, disambiguate the data, or flag other inconsistencies. The components could then subscribe to receive particular pieces of information or to be notified of relevant data updates. The updates can be constrained by the conditions in the pattern supplied at subscription time. For example, a component may only ask to be notified about objects that are nearby or objects that can be picked up.

In this specification, a robot is a machine having a base position, one or more movable components, and a kinematic model that can be used to map desired positions, poses, or both in one coordinate system, e.g., Cartesian coordinates, into commands for physically moving the one or more movable components to the desired positions or poses. In this specification, a tool is a device that is part of and is attached at the end of the kinematic chain of the one or more moveable components of the robot. Example tools include grippers, welding devices, and sanding devices.

In this specification, a task is an operation to be performed by a tool. For brevity, when a robot has only one tool, a task can be described as an operation to be performed by the robot as a whole. Example tasks include welding, glue dispensing, part positioning, and surfacing sanding, to name just a few examples. Tasks are generally associated with a type that indicates the tool required to perform the task, as well as a position within a workcell at which the task will be performed.

In this specification, a motion plan is a data structure that provides information for executing an action, which can be a task, a cluster of tasks, or a transition. Motion plans can be fully constrained, meaning that all values for all controllable degrees of freedom for the robot are represented explicitly or implicitly; or underconstrained, meaning that some values for controllable degrees of freedom are unspecified. In some implementations, in order to actually perform an action corresponding to a motion plan, the motion plan must be fully constrained to include all necessary values for all controllable degrees of freedom for the robot. Thus, at some points in the planning processes described in this specification, some motion plans may be underconstrained, but by the time the motion plan is actually executed on a robot, the motion plan can be fully constrained. In some implementations, motion plans represent edges in a task graph between two configuration states for a single robot. Thus, generally there is one task graph per robot.

In this specification, a motion swept volume is a region of the space that is occupied by at least a portion of a robot or tool during the entire execution of a motion plan. The motion swept volume can be generated by collision geometry associated with the robot-tool system.

In this specification, a transition is a motion plan that describes a movement to be performed between a start point and an end point. The start point and end point can be represented by poses, locations in a coordinate system, or tasks to be performed. Transitions can be underconstrained by lacking one or more values of one or more respective controllable degrees of freedom (DOF) for a robot. Some transitions represent free motions. In this specification, a free motion is a transition in which none of the degrees of freedom are constrained. For example, a robot motion that simply moves from pose A to pose B without any restriction on how to move between these two poses is a free motion. During the planning process, the DOF variables for a free motion are eventually assigned values, and path planners can use any appropriate values for the motion that do not conflict with the physical constraints of the workcell.

The robot functionalities described in this specification can be implemented by a hardware-agnostic software stack, or, for brevity just a software stack, that is at least partially hardware-agnostic. In other words, the software stack can accept as input commands generated by the planning processes described above without requiring the commands to relate specifically to a particular model of robot or to a particular robotic component. For example, the software stack can be implemented at least partially by the onsite execution system 110 and the robot interface subsystem 160 of FIG. 1.

The software stack can include multiple levels of increasing hardware specificity in one direction and increasing software abstraction in the other direction. At the lowest level of the software stack are robot components that include devices that carry out low-level actions and sensors that report low-level statuses. For example, robots can include a variety of low-level components including motors, encoders, cameras, drivers, grippers, application-specific sensors, linear or rotary position sensors, and other peripheral devices. As one example, a motor can receive a command indicating an amount of torque that should be applied. In response to receiving the command, the motor can report a current position of a joint of the robot, e.g., using an encoder, to a higher level of the software stack.

Each next highest level in the software stack can implement an interface that supports multiple different underlying implementations. In general, each interface between levels provides status messages from the lower level to the upper level and provides commands from the upper level to the lower level.

Typically, the commands and status messages are generated cyclically during each control cycle, e.g., one status message and one command per control cycle. Lower levels of the software stack generally have tighter real-time requirements than higher levels of the software stack. At the lowest levels of the software stack, for example, the control cycle can have actual real-time requirements. In this specification, real-time means that a command received at one level of the software stack must be executed and optionally, that a status message be provided back to an upper level of the software stack, within a particular control cycle time. If this real-time requirement is not met, the robot can be configured to enter a fault state, e.g., by freezing all operation.

At a next-highest level, the software stack can include software abstractions of particular components, which will be referred to motor feedback controllers. A motor feedback controller can be a software abstraction of any appropriate lower-level components and not just a literal motor. A motor feedback controller thus receives state through an interface into a lower-level hardware component and sends commands back down through the interface to the lower-level hardware component based on upper-level commands received from higher levels in the stack. A motor feedback controller can have any appropriate control rules that determine how the upper-level commands should be interpreted and transformed into lower-level commands. For example, a motor feedback controller can use anything from simple logical rules to more advanced machine learning techniques to transform upper-level commands into lower-level commands. Similarly, a motor feedback controller can use any appropriate fault rules to determine when a fault state has been reached. For example, if the motor feedback controller receives an upper-level command but does not receive a lower-level status within a particular portion of the control cycle, the motor feedback controller can cause the robot to enter a fault state that ceases all operations.

At a next-highest level, the software stack can include actuator feedback controllers. An actuator feedback controller can include control logic for controlling multiple robot components through their respective motor feedback controllers. For example, some robot components, e.g., a joint arm, can actually be controlled by multiple motors. Thus, the actuator feedback controller can provide a software abstraction of the joint arm by using its control logic to send commands to the motor feedback controllers of the multiple motors.

At a next-highest level, the software stack can include joint feedback controllers. A joint feedback controller can represent a joint that maps to a logical degree of freedom in a robot. Thus, for example, while a wrist of a robot might be controlled by a complicated network of actuators, a joint feedback controller can abstract away that complexity and exposes that degree of freedom as a single joint. Thus, each joint feedback controller can control an arbitrarily complex network of actuator feedback controllers. As an example, a six degree-of-freedom robot can be controlled by six different joint feedback controllers that each control a separate network of actual feedback controllers.

Each level of the software stack can also perform enforcement of level-specific constraints. For example, if a particular torque value received by an actuator feedback controller is outside of an acceptable range, the actuator feedback controller can either modify it to be within range or enter a fault state.

To drive the input to the joint feedback controllers, the software stack can use a command vector that includes command parameters for each component in the lower levels, e.g. a positive, torque, and velocity, for each motor in the system. To expose status from the joint feedback controllers, the software stack can use a status vector that includes status information for each component in the lower levels, e.g., a position, velocity, and torque for each motor in the system. In some implementations, the command vectors also include some limit information regarding constraints to be enforced by the controllers in the lower levels.

At a next-highest level, the software stack can include joint collection controllers. A joint collection controller can handle issuing of command and status vectors that are exposed as a set of part abstractions. Each part can include a kinematic model, e.g., for performing inverse kinematic calculations, limit information, as well as a joint status vector and a joint command vector. For example, a single joint collection controller can be used to apply different sets of policies to different subsystems in the lower levels. The joint collection controller can effectively decouple the relationship between how the motors are physically represented and how control policies are associated with those parts. Thus, for example if a robot arm has a movable base, a joint collection controller can be used to enforce a set of limit policies on how the arm moves and to enforce a different set of limit policies on how the movable base can move.

At a next-highest level, the software stack can include joint selection controllers. A joint selection controller can be responsible for dynamically selecting between commands being issued from different sources. In other words, a joint selection controller can receive multiple commands during a control cycle and select one of the multiple commands to be executed during the control cycle. The ability to dynamically select from multiple commands during a real-time control cycle allows greatly increased flexibility in control over conventional robot control systems.

At a next-highest level, the software stack can include joint position controllers. A joint position controller can receive goal parameters and dynamically compute commands required to achieve the goal parameters. For example, a joint position controller can receive a position goal and can compute a set point for achieve the goal.

At a next-highest level, the software stack can include Cartesian position controllers and Cartesian selection controllers. A Cartesian position controller can receive as input goals in Cartesian space and use inverse kinematics solvers to compute an output in joint position space. The Cartesian selection controller can then enforce limit policies on the results computed by the Cartesian position controllers before passing the computed results in joint position space to a joint position controller in the next lowest level of the stack. For example, a Cartesian position controller can be given three separate goal states in Cartesian coordinates x, y, and z. For some degrees, the goal state could be a position, while for other degrees, the goal state could be a desired velocity.

These functionalities afforded by the software stack thus provide wide flexibility for control directives to be easily expressed as goal states in a way that meshes naturally with the higher-level planning techniques described above. In other words, when the planning process uses a process definition graph to generate concrete actions to be taken, the actions need not be specified in low-level commands for individual robotic components. Rather, they can be expressed as high-level goals that are accepted by the software stack that get translated through the various levels until finally becoming low-level commands. Moreover, the actions generated through the planning process can be specified in Cartesian space in way that makes them understandable for human operators, which makes debugging and analyzing the schedules easier, faster, and more intuitive. In addition, the actions generated through the planning process need not be tightly coupled to any particular robot model or low-level command format. Instead, the same actions generated during the planning process can actually be executed by different robot models so long as they support the same degrees of freedom and the appropriate control levels have been implemented in the software stack.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1

is a method comprising:

continually evaluating, by an execution subsystem configured to drive one or more robots in an operating environment, a plurality of execution predicates, wherein each execution predicate comprises a rule having a predicate value, and wherein, whenever a state value that satisfies the predicate value of the predicate is detected by the execution subsystem, the execution subsystem triggers a corresponding action to be performed in the operating environment by the one or more robots;

continually executing, by a state estimator, a state estimation function using one or more sensor values or status messages obtained from the operating environment; and

automatically updating a discrete state value for a first execution predicate of the plurality of execution predicates evaluated by the execution subsystem, thereby causing the executing subsystem to trigger a corresponding action to be performed by one or more robots in the operating environment.

Embodiment 2 is the method of embodiment 1, wherein the state estimation function operates on status messages streamed from the operating environment.

Embodiment 3 is the method of embodiment 2, wherein the state estimation function specifies one or more filter criteria for the status messages, and wherein the state estimator is configured to further process messages according to the one or more filter criteria.

Embodiment 4 is the method of any one of embodiments 1-3, wherein the execution subsystem is configured to drive a plurality of physical robots in a physical operating environment.

Embodiment 5 is the method of embodiment 4, wherein the one or more sensor values received by the state estimator comprise sensor values received from one or more physical sensors in a robotic workcell.

Embodiment 6 is the method of any one of embodiments 1-5, wherein the state estimation function is configured to convert a quantitative measurement of the robotic operating environment into a discrete state value.

Embodiment 7 is the method of any one of embodiments 1-6, wherein the state estimator operates independently and at a different update rate than the execution subsystem.

Embodiment 8 is the method of any one of embodiments 1-7, wherein the state estimation function is a custom state estimation function defined by an entity operating the robots in the operating environment.

Embodiment 9 is the method of any one of embodiments 1-8, wherein the execution subsystem is configured to execute a recovery operation in response to a new state value being generated by the state estimator.

Embodiment 10 is the method of any one of embodiments 1-9, wherein the state estimation function is implemented by a machine learning model having a plurality of parameter values that convert an input to an output having the discrete value for the first execution predicate.

Embodiment 11 is the method of embodiment 10, wherein the execution subsystem is a rule-based system that uses values generated by the machine learning model.

Embodiment 12 is the method of any one of embodiments 1-11, wherein the execution subsystem is a virtual execution subsystem driven by a simulation for the one or more robots.

Embodiment 13 is the method of embodiment 12, wherein the one or more sensor values received by the state estimator comprise simulated sensor values

Embodiment 14 is a system comprising: one or more computers and one or more storage devices storing instructions that are operable, when executed by the one or more computers, to cause the one or more computers to perform the method of any one of embodiments 1 to 13.

Embodiment 15 is a computer storage medium encoded with a computer program, the program comprising instructions that are operable, when executed by data processing apparatus, to cause the data processing apparatus to perform the method of any one of embodiments 1 to 13.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A system comprising:
an execution subsystem configured to drive one or more robots in an operating environment including continually evaluating a plurality of execution predicates, wherein each execution predicate comprises a rule having a predicate value, and wherein, whenever a state value that satisfies the predicate value of the predicate is detected by the execution subsystem, the execution subsystem is configured to trigger a corresponding action to be performed in the operating environment by the one or more robots; and
a state estimator configured to continually execute a state estimation function using one or more sensor values or status messages obtained from the operating environment and to automatically update a discrete state value for a first execution predicate of the plurality of execution predicates evaluated by the execution subsystem.

2. The system of claim 1, wherein the state estimation function operates on status messages streamed from the operating environment.

3. The system of claim 2, wherein the state estimation function specifies one or more filter criteria for the status messages, and wherein the state estimator is configured to further process messages according to the one or more filter criteria.

4. The system of claim 1, wherein the execution subsystem is configured to drive a plurality of physical robots in a physical operating environment.

5. The system of claim 4, wherein the one or more sensor values received by the state estimator comprise sensor values received from one or more physical sensors in a robotic workcell.

6. The system of claim 1, wherein the state estimation function is configured to convert a quantitative measurement of the robotic operating environment into a discrete state value.

7. The system of claim 1, wherein the state estimator operates independently and at a different update rate than the execution subsystem.

8. The system of claim 1, wherein the state estimation function is a custom state estimation function defined by an entity operating the robots in the operating environment.

9. The system of claim 1, wherein the execution subsystem is configured to execute a recovery operation in response to a new state value being generated by the state estimator.

10. The system of claim 1, wherein the state estimation function is implemented by a machine learning model having a plurality of parameter values that convert an input to an output having the discrete value for the first execution predicate.

11. The system of claim 10, wherein the execution subsystem is a rule-based system that uses values generated by the machine learning model.

12. The system of claim 1, wherein the execution subsystem is a virtual execution subsystem driven by a simulation for the one or more robots.

13. The system of claim 12, wherein the one or more sensor values received by the state estimator comprise simulated sensor values.

14. A method performed by one or more computers, the method comprising:
continually evaluating, by an execution subsystem configured to drive one or more robots in an operating environment, a plurality of execution predicates, wherein each execution predicate comprises a rule having a predicate value, and wherein, whenever a state value that satisfies the predicate value of the predicate is detected by the execution subsystem, the execution subsystem triggers a corresponding action to be performed in the operating environment by the one or more robots;
continually executing, by a state estimator, a state estimation function using one or more sensor values or status messages obtained from the operating environment; and
automatically updating a discrete state value for a first execution predicate of the plurality of execution predicates evaluated by the execution subsystem, thereby causing the executing subsystem to trigger a corresponding action to be performed by one or more robots in the operating environment.

15. The method claim 14, wherein the state estimation function operates on status messages streamed from the operating environment.

16. The method of claim 15, wherein the state estimation function specifies one or more filter criteria for the status messages, and wherein the state estimator further processes messages according to the one or more filter criteria.

17. The system of claim 1, wherein the execution subsystem drives a plurality of physical robots in a physical operating environment.

18. The system of claim 1, wherein the state estimator operates independently and at a different update rate than the execution subsystem.

19. The system of claim 1, wherein the state estimation function is a custom state estimation function defined by an entity operating the robots in the operating environment.

20. One or more non-transitory computer storage media encoded with computer program instructions that when executed by one or more computers cause the one or more computers to perform operations comprising:
continually evaluating, by an execution subsystem configured to drive one or more robots in an operating environment, a plurality of execution predicates, wherein each execution predicate comprises a rule having a predicate value, and wherein, whenever a state value that satisfies the predicate value of the predicate is detected by the execution subsystem, the execution subsystem triggers a corresponding action to be performed in the operating environment by the one or more robots;
continually executing, by a state estimator, a state estimation function using one or more sensor values or status messages obtained from the operating environment; and
automatically updating a discrete state value for a first execution predicate of the plurality of execution predicates evaluated by the execution subsystem, thereby causing the executing subsystem to trigger a corresponding action to be performed by one or more robots in the operating environment.
